(19) United States
(12) Patent Application Publication
(10) Pub. No.: US 2026/0361056 A1
(43) Pub. Date: Nov. 12, 2026

(54) SPARK PLUG TESTING

(71) Applicant: Cummins Inc., Columbus, IN (US)

(72) Inventors: Sujay Sudhir Kulkarni, Pune (IN); Timothy J. Viola, Columbus, IN (US); Malcolm L. Smith, Indianapolis, IN (US); Steven Wilson, Bloomington, IN (US); Russell Khajuria, Jammu (IN); Ryan Baize, Columbus, IN (US)

(21) Appl. No.: 19/202,128

(22) Filed: May 8, 2025

(51) Int. Cl. H01T 13/58

(52) U.S. Cl. CPC H01T 13/58

(57) ABSTRACT

A process for testing one or more spark plugs of an engine includes, while the engine is stopped, performing acts of providing a surrogate signal to a controller, the surrogate signal being a surrogate for an engine angle signal provided to the controller during operation of the engine, providing a spark plug test signal to the controller, operating the controller to output a firing signal to a driver circuit in response to the spark plug test signal and the surrogate crank angle signal, operating the driver circuit to fire a spark plug in response to the firing signal, and evaluating presence or absence of a spark in response to the operation of the driver circuit.

### TECHNICAL FIELD

The present application relates to testing of spark plugs for engines and more particularly but not exclusively to tests to selectively ignite spark plugs to detect ignition faults when an engine is not running.

### BACKGROUND

Various proposals have been made for testing spark plugs. Existing proposals suffer from a number of disadvantages and shortcomings including those respecting accuracy, complexity, cost, ease of testing, efficacy, reliability, robustness, and others. For example, conventional testing involves technicians turning off the fuel lines, removing spark plugs, sealing the spark plugs, cranking the engine, and observing sparking generated by operation of the spark plugs. Such procedures are a tedious, time consuming, and potentially inaccurate. There remains a significant need for the unique apparatuses, methods, systems, and techniques of the present disclosure.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique apparatuses for testing one or more spark plugs while an engine is not running. Some embodiments include unique methods for testing one or more spark plugs while an engine is not running. Some embodiments include unique systems for testing one or more spark plugs while an engine is not running. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example powertrain system.

FIG. 2 is a schematic diagram illustrating certain aspects of an example ignition system.

FIG. 3 is a flow diagram illustrating certain aspects of an example process.

FIG. 4 is a flow diagram illustrating certain aspects of an example process.

### DETAILED DESCRIPTION OF EXAMPLE EMBODIMENTS

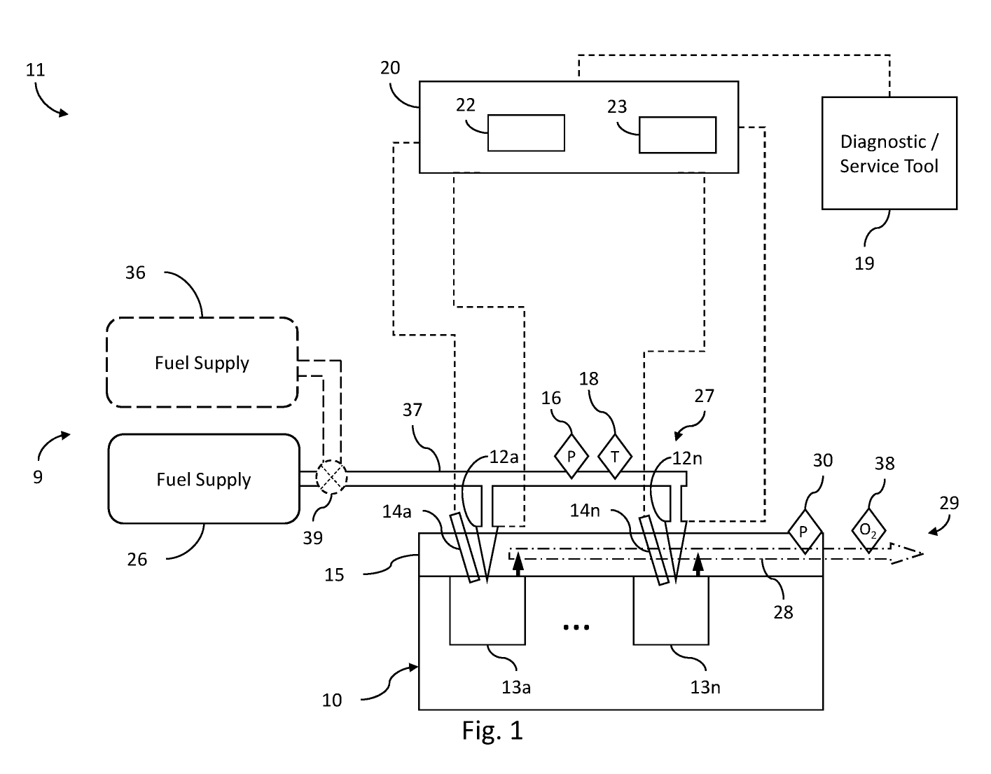

With reference to FIG. 1, there is illustrated an example powertrain system 11 (also referred to herein as system 11) comprising a fueling system 9 and an engine 10. Fueling system 9 is adapted and configured to supply gaseous fuel for combustion to engine 10. In some embodiments, fueling system 9 may adapted and configured to supply gaseous hydrocarbon (CₓH_{y}), gaseous hydrogen, other gaseous fuels, or combinations thereof to engine 10 for combustion. spark-ignited fuels. In some embodiments, fueling system 9 may adapted and configured to supply gaseous hydrocarbon (e.g., natural gas, liquified petroleum gas, wellhead gas, biogas, or other gaseous hydrocarbons), gaseous hydrogen, other gaseous fuels, gasoline, alcohols, gasoline, alcohols, other spark-ignited fuels, or combinations thereof to engine 10 for combustion. Engine 10 comprises combustion chambers 13 (also referred to as cylinders) of a reciprocating piston-in-cylinder type which are configured to generate mechanical power from the combustion of gaseous fuel supplied by fuel injectors 12a, 12n. System 11 may be provided in a number of forms including as a prime mover system (or component of a prime mover system) of vehicle, a genset, other power-load system.

Fuel injectors 12a, 12n are in fluid communication with respective combustion chambers 13a, 13n of the engine 10 and are structured to inject gaseous fuel which is provided to their respective combustion chambers 13a, 13n. In the illustrated embodiment, fuel injectors 12 are configured and provided as port fuel injectors configured to inject fuel directly into respective ports of intake manifold 15 leading to respective combustion chambers 13 of engine 10. Other embodiments may include other types and configurations of injectors such as direct fuel injectors configured to inject fuel directly into respective combustion chambers of engine 10. In the illustrated embodiment, two fuel injectors 12a, 12n and two combustion chambers 13a, 13n are depicted, it being appreciated that engine 10 may include fewer or greater numbers of fuel injectors and combustion chambers arranged and configured in a variety of manners.

In the illustrated embodiment, fueling system 9 includes a fuel supply 26 and a gaseous fuel injection system 27. Injection system 27 may include one or more rails and one or more sets of injectors (e.g., injectors 12a, 12n or other injectors) operatively coupled with and supplied with gaseous fuel from a respective one of the one or more rails. The one or more rails are, in turn, configured to receive pressurized fuel from fuel supply 26.

In some embodiments, fueling system 9 may include a second fuel supply 36 which is configured to introduce a second fuel for combustion to engine 10. In the illustrated example, fuel supply 36 is adapted to introduce a second fuel via a valve and mixer system 39 which can selectably vary the relative proportion of fuels provided for combustion by engine 10. In other embodiments, gaseous hydrocarbon fuel supply 36 may be provided with separate rails and injectors which may be adapted to inject gaseous hydrocarbon fuel into a respective port or directly into respective cylinders separately from the rails and injectors that supply hydrogen for combustion by engine 10.

In some embodiments, fueling system 9 may include additional elements such as a compressor configured to compress gaseous fuel received from the fuel tank supply compressed gaseous fuel to the one or more rails, and/or and accumulator as well as electronically controllable valves configured to control supply of gaseous fuel to and from the accumulator and/or the one or more rails.

Spark plugs 14a, 14n are in operative communication with respective combustion chambers 13a, 13n of the engine 10 and are structured to provide spark ignition of gaseous fuel, which is provided to their respective combustion chambers 13a, 13n. While two spark plugs 14a, 14n are depicted in the illustrated example, it shall be appreciated that the present disclosure contemplates various other numbers of spark plugs, such as 6, 8, 12, 16, 20, and 24 (as may correspond to the number of cylinders present in several example engines or, in principle, any number of spark plugs.

System 11 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include a pressure sensor 16 and a temperature sensor 18. The pressure sensor 16 is in communication with the common fuel rail 37 and structured to communicate a measurement of the pressure within the common fuel rail 37 to the ECS 20. The temperature sensor 18 is in communication with the common fuel rail 37 and structured to communicate a measurement of the temperature within the common fuel rail 37 to the ECS 20.

System 11 further includes exhaust system 29 including exhaust manifold 28 various conduits and aftertreatment components and systems as will occur to one of skill in the art with the benefit and insight of the present disclosure. In the illustrated example, exhaust system 29 includes a pressure sensor 30 in operative communication with ECS 20 and configured and operable to sense exhaust pressure and provide one or more signals indicative thereof to ECS 20. Pressure sensor 30 may be configured and provided, for example, as an exhaust manifold pressure (EMP) configured to sense pressure in or associated with exhaust manifold 28 or as another sensor configuration or type as will occur to one of skill in the art with the benefit and insight of the present disclosure. Output of pressure sensor 30 provided to ECS 20 may be utilized for control, diagnostic, prognostic, and other purposes. As further described herein, such purposes may include detection or diagnosis of preignition events (including early preignition events), and discrimination between preignition, misfire, and normal or desired combustion events.

In the illustrated example, exhaust system 29 includes oxygen (O₂) sensor 38 in operative communication with ECS 20 and configured and operable to sense a one or more characteristics indicative of a concentration of oxygen of exhaust output by engine 10 and to provide one or more signals indicative thereof to ECS 20. Oxygen sensor 38 may be configured and provided, for example, as a lambda sensor or as another sensor configuration or type as will occur to one of skill in the art with the benefit and insight of the present disclosure. Output of oxygen sensor 38 provided to ECS 20 may be utilized for control, diagnostic, prognostic, and other purposes.

ECS 20 may include one or more controllers for controlling different aspects of the system 11. In one form ECS 20 comprises one or more electronic control units (ECU) such as an engine control unit or engine control module. ECS 20 may be comprised of digital circuitry, analog circuitry, or a hybrid combination of both of these types. Also, ECS 20 may be programmable, an integrated state machine, or a hybrid combination thereof. ECS 20 may include one or more Arithmetic Logic Units (ALUs), Central Processing Units (CPUs), memories, limiters, conditioners, filters, format converters, or the like which are not shown to preserve clarity. In one form, ECS 20 is of a programmable variety that executes algorithms and processes data in accordance with operating logic that is defined by programming instructions (such as software or firmware). Alternatively or additionally, operating logic for ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of system 11. As used herein, the term sensors may include any suitable hardware and/or software used to sense or estimate any engine system parameter and/or various combinations of such parameters either directly or indirectly.

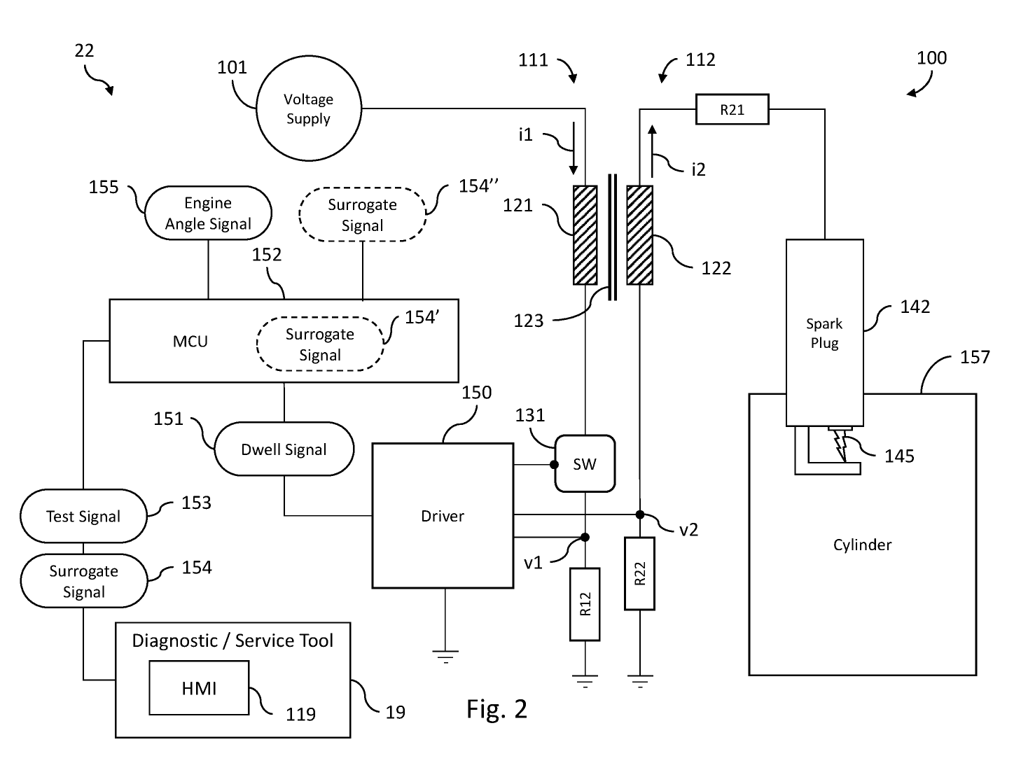

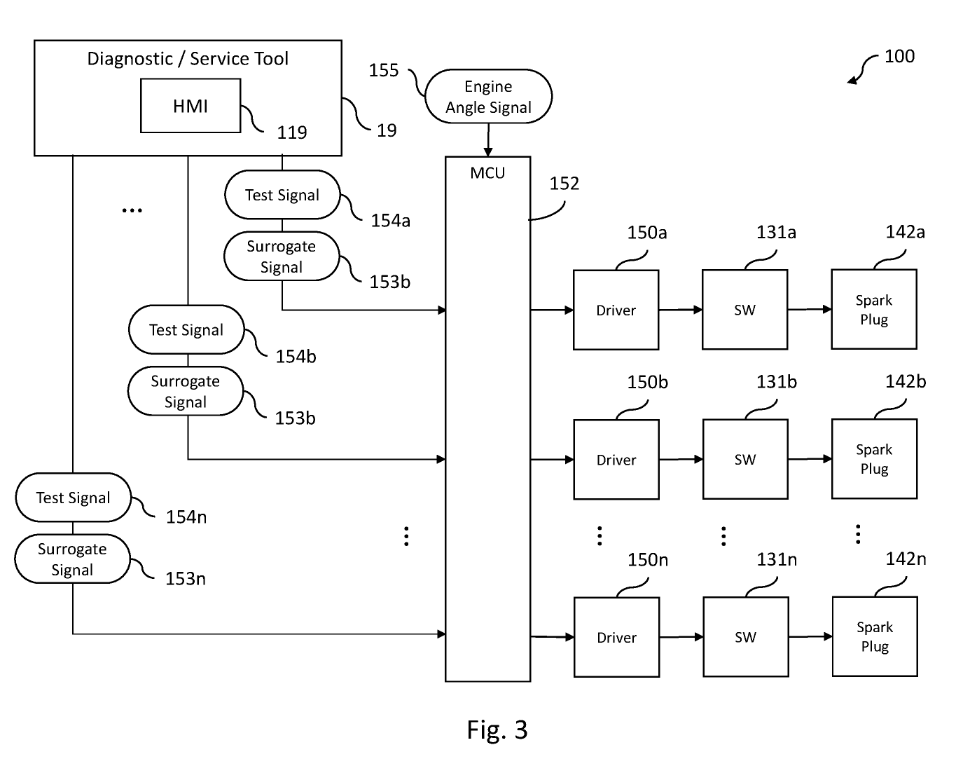

With reference to FIGS. 2 and 3, there is illustrated an ignition system 100 (also referred to herein as system 100) which may be provided and implemented in a powertrain system such as system 11. In the illustrated example, system 100 is configured as an inductive ignition system. It shall be appreciated that other embodiments may utilize other types of ignition systems including, for example, a capacitive discharge ignition system.

System 100 includes a primary circuit 111 comprising a first coil 121 operatively coupled with a voltage supply 101 and a switch 131 controllable to regulate a primary current i1 in the primary circuit 111. In the illustrated example, switch 131 is operatively coupled with and adapted to be controlled by a driver 150 which, in turn, is operatively coupled with and adapted to be controlled by a controller 152 to regulate a primary current i1 in the primary circuit 111.

Microcontroller 152 is configured to receive and process an engine angle signal 155 during operation of engine 10. The engine angle signal 155 may comprise signal indicative an engine crank angle, a signal indicative of an engine cam angle, or other signals indicative of engine angle as will occur to one of skill in the art with the benefit and insight of the present disclosure. Microcontroller 152 is configured to determine spark ignition timing and associated commands and/or other outputs in response to engine angle signal 155. Such timing may, for example, be determined utilizing one or more lookup tables, real-time computations, and/or other techniques as will occur to one of skill in the art with the benefit and insight of the present disclosure. In the illustrated example, controller 152 is configured to determine and output a dwell signal 151 to driver 150 to cause operation of switch 131 to provide sparking operation of spark plug 142, it being appreciated that other types of firing signals are also contemplated. Driver 150 may also monitor feedback voltages v1 and/or v2 to evaluate its operation, for example, whether spark plug 142 has successfully fired.

Diagnostic or service tool 19 is operatively coupled with and configured to communicate signals to controller 152 via one or more communication links. In some embodiments, diagnostic or service tool 19 may comprise a stand-alone diagnostic tool such as a laptop or other computer configured to perform spark plug testing (and potentially other service analytics or diagnostics) on one or more of a plurality of spark plugs of engine 10, or another engine, such as spark plugs 12a, 12n (or another set of one or more spark plugs). It shall be appreciated that spark plug testing according to the present disclosure may encompass and include testing of a spark line associated and configured to supply current to a spark plug, and that a spark plug test according to the present disclosure may comprise a test of such a spark line. In some embodiments, diagnostic or service tool 19 may comprise an on-powertrain or on-vehicle system operatively coupled with controller 152 and configured to perform the aforementioned spark plug testing. In some embodiments, diagnostic or service tool 19 may comprise a tool distributed across or among an on-powertrain or on-vehicle system operatively coupled with controller 152 and configured to perform the aforementioned spark plug testing. In any of the foregoing embodiments,

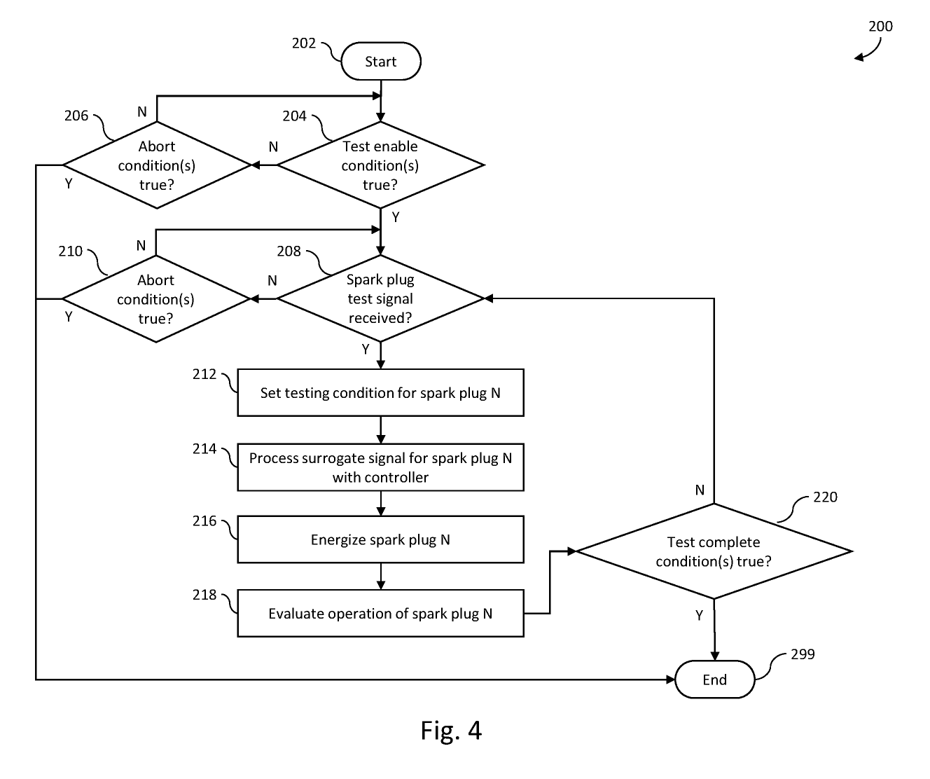

Microcontroller 152 is configured to receive and process a spark plug test signal 153 from diagnostic or service tool 19 to initiate a spark plug test procedure such as process 200 described on connection with FIG. 4 or another test procedure as will occur to one of skill in the art with the benefit and insight of the present disclosure. Spark plug test signal 153 may comprise any one or more of a signal indicating that a spark plug test should be initiated, identifying one or more spark plugs for testing, identifying an order of testing for a plurality of spark plugs, and other test signals as will occur to one of skill in the art with the benefit and insight of the present disclosure.

Microcontroller 152 is configured to receive and process a surrogate signal 154 when engine 10 is stopped. Surrogate signal 154 may be generated and provided by diagnostic or service tool 19 (as primarily depicted in the illustrated example), by controller 152 itself (as denoted by surrogate signal 154’), by another control system component external to controller 152 (and potentially external to the ECU in which controller 152 is implemented), or by a combination of the foregoing.

Primary circuit 111 may further include a resistor R12 coupled with the switch 131 and with ground. The switch 131 may be provided in a number of forms including, for example, an insulated gate bipolar transistor (IGBT), a power metal oxide silicon field effect transistor (MOSFET) such as a silicon carbide (SiC) MOSFET, or other types of switching devices as will occur to one of skill in the art with the benefit and insight of the present disclosure.

System 100 includes a secondary circuit 112 comprising a second coil 122 operatively coupled with a spark plug 142. Secondary circuit 112 may further include one or more current protection device(s) 132, for example, one or more diodes. Secondary circuit 112 may also include a resistor R21 coupled with the second coil 122 and with the spark plug 142, and a resistor R22 coupled with the current protection device(s) 132 and with ground.

A core 123 magnetically couples the first coil 121 and the second coil 122 and transfers energy from the first coil 121 to the second coil 122 during operation of ignition system 100. For example, during operation, controller 152 and driver 150 may close or otherwise operate switch 131 to cause the primary current i1 to flow to the first coil 121 and may thereafter open switch 131 to interrupt the path to ground of the primary current i1. The primary current i1 induces a magnetic field in core 123 by which energy is transferred the second coil 122. As a result, a secondary current i2 is induced in the secondary circuit and flows to spark plug 142. In response, when the spark plug 142 becomes sufficient charged, a spark 145 is generated in combustion cylinder 157 to ignite a hydrogen-based fuel such as gaseous hydrogen (H₂) or a mixture or combination of H₂ and gaseous hydrocarbon (C_{X}H_{Y}).

Controller 152 may be provided in a number of forms including, for example, as a microcontroller or microprocessor-based or another integrated circuit-based electronic controller. Controller 150 may be provided as a component of an electronic control system such as ECS 20 or another electronic control system, and may be provided as a stand-alone or discrete control component or implemented in combination with other control components in a variety of manners as will occur to one of skill in the art with the benefit and insight of the present disclosure.

As further illustrated in FIG. 3, system 100 and diagnostic or service tool 19 may be configured to provide a plurality of spark plug-specific test signals 154a, 154b, 154n to controller 152. Diagnostic or service tool 19 may also be configured to provide a plurality of surrogate signals 153a, 153b, 153n to controller 152. In turn, controller 152 may be configured to provide a respective plurality of firing signals to drivers 150a, 150b, 150n which may, in turn, be configured to operate a respective plurality of switches 131a, 131b, 131n, to fire a respective plurality of spark plugs 142a, 142b, 142n. It shall be appreciated that the testing of multiple spark plugs such as spark plugs 142a, 142b, 142n or other spark plugs according to the present disclosure may be initiated by input received via a human machine interface 119 of diagnostic or service tool 19. Such inputs may comprise, for example, individual inputs to test specific ones of spark plugs 142a, 142b, 142n (or other spark plugs) or a general signal to sequentially test a plurality of spark plugs 142a, 142b, 142n or other spark plugs.

With reference to FIG. 4, there is illustrated an example process 200 for operating an electronic control system (e.g., ECS 20 or another electronic control system), in operative communication with a fueling system (e.g., fueling system 9 or another fueling system). Process 200 may be implemented in and performed by one or more components of an electronic control system such as one or more electronic control units (e.g., ECU 22 and/or other electronic control units) and/or by other electronic control system components.

Process 200 begins at start operation 202 and proceeds to conditional 204 which tests whether one or more enable conditions are true. The one or more enable conditions may comprise, for example, one or more of the engine not running, no spark line or other spark plug related faults being active, a fuel shut-off valve being closed, and other enable conditions as will occur to one of skill in the art with the benefit and insight of the present disclosure. Conditional 204 may, for example, evaluate whether engine 10 is stopped or not running, evaluate whether FSOV 39 is closed, and evaluate whether the fault condition(s) associated with fuel injection system 27 are not true, and, if each of these evaluations is affirmative, evaluate affirmative overall or, if any one or more of these evaluations is negative, evaluate negative overall.

If conditional 204 evaluates negative, process 200 proceeds to conditional 206 which evaluates whether one or more abort conditions are true. The one or more abort conditions may comprise one or more time-out conditions, one or more number of attempts conditions, or other conditions as will occur to one of skill in the art with the benefit and insight of the present disclosure. If conditional 206 evaluates negative, process 200 proceeds to conditional 204. If conditional 206 evaluates affirmative, process 200 proceeds to end operation 299 and may thereafter be recalled, reinitiated, or repeated.

If conditional 204 evaluates affirmative, process 200 proceeds to conditional 208 which evaluates whether a spark plug test signal has been received. The spark plug test signal may comprise, for example, spark plug test signal 153 or another spark plug test signal as will occur to one of skill in the art with the benefit and insight of the present disclosure.

If conditional 208 evaluates negative, process 200 proceeds to conditional 210 which evaluates whether one or more abort conditions are true. The one or more abort conditions may comprise one or more time-out conditions, one or more number of attempts conditions, or other conditions as will occur to one of skill in the art with the benefit and insight of the present disclosure. If conditional 210 evaluates negative, process 200 proceeds to conditional 208. If conditional 206 evaluates affirmative, process 200 proceeds to end operation 299 and may thereafter be recalled, reinitiated, or repeated.

If conditional 208 evaluates affirmative, process 200 proceeds to operation 212 which sets a testing condition for a particular spark plug (N) which may be indicated by the spark plug test signal, another input, or a defined test order stored in a non-transitory memory of a controller.

From operation 212, process 200 proceeds to operation 214 at which a surrogate signal is provided at and processed by the controller. The surrogate signal may comprise, for example, surrogate signal 154, 154’, 154’’ or another surrogate signal as will occur to one of skill in the art with the benefit and insight of the present disclosure. The surrogate signal may be obtained from a source internal to the controller or received from a source external to the controller such as a diagnostic or service tool or another external source. The controller may process the surrogate signal and, in response, generate and output a firing signal, such as a dwell signal or another firing signal as will occur to one of skill in the art with the benefit and insight of the present disclosure.

From operation 214, process 200 proceeds to operation 216 which energizes the particular spark plug (N). Operation 216 may comprise, for example, operating a driver circuit and an associated switch to fire the particular spark plug n to a firing signal generated in response to the surrogate signal.

From operation 216, process 200 proceeds to operation 218 at which operation of the particular spark plug (N) is evaluated in response to the operation of the driver circuit. In some embodiments, the evaluation may comprise a judgment reached using the driver circuit and/or controller with which it is operatively coupled based on sensed voltage and/or current conditions detected or determined form monitoring aspects of the ignition system. In some embodiments, the evaluation may comprise a visual inspection by a human technician and input provided to an HMI of a diagnostic or service tool indicative of whether a spark is observed or not.

From operation 208, process 200 proceeds to conditional 220 which evaluates whether one or more test complete conditions is true. The one or more test complete conditions may comprise, for example, an evaluation whether additional test requests are present or expected an evaluation whether all spark plugs of a given system have been tested, or other conditions as will occur to one of skill in the art with the benefit and insight of the present disclosure. If conditional 220 evaluates negative, process 200 proceeds to conditional 208. If conditional 220 evaluates affirmative, process 200 proceeds to end operation 299 and may thereafter be recalled, reinitiated, or repeated.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

As illustrated by this detailed description, the present disclosure contemplated a plurality of embodiments including, without limitation, the following example embodiments.

Example embodiment number 1 is a process for testing one or more spark plugs of an engine, the process comprising: while the engine is stopped, performing acts of: providing a spark plug test signal to a controller, the controller being operatively coupled with an ignition system including a plurality of spark plugs, a plurality of switches operatively coupled with the plurality of spark plugs, and a plurality of driver circuits operatively coupled with the plurality of switches; providing a surrogate signal to the controller, the surrogate signal being a surrogate for an engine angle signal provided to the controller during operation of the engine; operating the controller to output a firing signal to one of the driver circuits in response to the spark plug test signal and the surrogate signal; operating the one of the driver circuits and an associated one of the plurality of switches to fire an associated one of the plurality of spark plugs in response to the firing signal; and evaluating presence or absence of a spark of the spark plug in response to the operation of the driver circuit.

Example embodiment number 2 includes the features of example embodiment number 1, comprising receiving with a human machine interface an operator selection to test a spark plug, wherein the act of providing the spark plug test signal to the controller occurs in response to the operator selection.

Example embodiment number 3 includes the features of example embodiment number 2, wherein the human machine interface is implemented in a diagnostic tool external to an electronic control unit (ECU) in which the controller is implemented.

Example embodiment number 4 includes the features of example embodiment number 1, comprising: providing a second surrogate signal to the controller, the second surrogate signal being a surrogate for the engine angle signal provided to the controller of the engine; providing a second spark plug test signal to the controller, the second spark plug test signal corresponding to a different one of a plurality of spark plugs than the spark plug test signal; operating the controller to output a second firing signal to a driver circuit in response to the second spark plug test signal and the second surrogate signal; operating the driver circuit to fire a second spark plug in response to the second firing signal; and evaluating presence or absence of a second spark of the second spark plug in response to the operation of the driver circuit.

Example embodiment number 5 includes the features of example embodiment number 1, wherein the act of providing the surrogate signal to the controller comprises: generating a synthetic engine angle signal with testing hardware operatively coupled with an electronic control unit (ECU) in which the controller is implemented, providing the synthetic engine angle signal to the controller, and operating the controller to output the firing signal to a driver circuit in response to the synthetic engine angle signal.

Example embodiment number 6 includes the features of example embodiment number 5, wherein the testing hardware comprises a diagnostic tool external to the ECU.

Example embodiment number 7 includes the features of example embodiment number 1, wherein the act of providing the surrogate signal to the controller comprises: generating a synthetic engine angle signal with test instructions executed by an electronic control unit (ECU) in which the controller is implemented, providing the synthetic engine angle signal to the controller, and operating the controller to output the firing signal to a driver circuit in response to the synthetic engine angle signal.

Example embodiment number 8 includes the features of example embodiment number 7, wherein the test instructions are stored in testing hardware external the ECU.

Example embodiment number 9 includes the features of example embodiment number 1, wherein the act of providing the surrogate signal to the controller comprises: operating a timer to trigger a time-based spark driver command, providing the time-based spark driver command to the controller, and operating the controller to output the firing signal to a driver circuit in response to the time-based spark driver command.

Example embodiment number 10 includes the features of example embodiment number 9, wherein the timer is implemented in testing hardware external an electronic control unit (ECU) in which the controller is implemented.

Example embodiment number 11 includes the features of example embodiment number 1, wherein the process is performed while a hybrid vehicle system including the engine is in motion with the engine turned off.

Example embodiment number 12 is a system for testing one or more spark plugs of an engine, the system comprising: an electronic test system including one or more processors and one or more non-transitory processor-readable media configured to operate while the engine is stopped to: provide a spark plug test signal to a controller, the controller being operatively coupled with an ignition system including a plurality of spark plugs, a plurality of switches operatively coupled with the plurality of spark plugs, and a plurality of driver circuits operatively coupled with the plurality of switches; provide a surrogate signal to the controller, the surrogate signal being a surrogate for an engine angle signal provided to the controller during operation of the engine; operate the controller to output a firing signal to one of the driver circuits in response to the spark plug test signal and the surrogate signal; operate the one of the driver circuits and an associated one of the plurality of switches to fire an associated one of the plurality of spark plugs in response to the firing signal; and evaluate presence or absence of a spark of the spark plug in response to the operation of the driver circuit.

Example embodiment number 13 includes the features of example embodiment number 12, comprising: a human machine interface configured to receive an operator selection to test a spark plug, wherein the electronic test system is configured to provide the spark plug test signal to the controller in response to the operator selection.

Example embodiment number 14 includes the features of example embodiment number 13, wherein the human machine interface is implemented in a diagnostic tool external to an electronic control unit (ECU) in which the controller is implemented.

Example embodiment number 15 includes the features of example embodiment number 12, wherein the electronic test system is configured to: provide a second surrogate signal to the controller, the second surrogate signal being a surrogate for the engine angle signal provided to the controller of the engine; provide a second spark plug test signal to the controller, the second spark plug test signal corresponding to a different one of a plurality of spark plugs than the spark plug test signal; operate the controller to output a second firing signal to a driver circuit in response to the second spark plug test signal and the second surrogate signal; operate the driver circuit to fire a second spark plug in response to the second firing signal; and evaluate presence or absence of a second spark of the second spark plug in response to the operation of the driver circuit.

Example embodiment number 16 includes the features of example embodiment number 12, wherein the electronic test system being configured to provide the surrogate signal to the controller comprises the electronic test system being configured to: generate a synthetic engine angle signal with testing hardware operatively coupled with an electronic control unit (ECU) in which the controller is implemented, provide the synthetic engine angle signal to the controller, and operate the controller to output the firing signal to a driver circuit in response to the synthetic engine angle signal.

Example embodiment number 17 includes the features of example embodiment number 16, wherein the testing hardware comprises a diagnostic tool external to the ECU.

Example embodiment number 18 includes the features of example embodiment number 12, wherein the electronic test system being configured to provide the surrogate signal to the controller comprises the electronic test system being configured to: generate a synthetic engine angle signal with test instructions executed by an electronic control unit (ECU) in which the controller is implemented, provide the synthetic engine angle signal to the controller, and operate the controller to output the firing signal to a driver circuit in response to the synthetic engine angle signal.

Example embodiment number 19 includes the features of example embodiment number 18, wherein the test instructions are stored in testing hardware external the ECU.

Example embodiment number 20 includes the features of example embodiment number 12, wherein the electronic test system being configured to provide the surrogate signal to the controller comprises the electronic test system being configured to: operate a timer to trigger a time-based spark driver command, provide the time-based spark driver command to the controller, and operate the controller to output the firing signal to a driver circuit in response to the time-based spark driver command.

Example embodiment number 21 includes the features of example embodiment number 20, wherein the timer is implemented in testing hardware external an electronic control unit (ECU) in which the controller is implemented.

Example embodiment number 22 includes the features of example embodiment number 12, wherein the electronic test system is configured to operate while a hybrid vehicle system including the engine is in motion with the engine turned off.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A process for testing one or more spark plugs of an engine, the process comprising:
while the engine is stopped, performing acts of
providing a spark plug test signal to a controller, the controller being operatively coupled with an ignition system including a plurality of spark plugs, a plurality of switches operatively coupled with the plurality of spark plugs, and a plurality of driver circuits operatively coupled with the plurality of switches;
providing a surrogate signal to the controller, the surrogate signal being a surrogate for an engine angle signal provided to the controller during operation of the engine;
operating the controller to output a firing signal to one of the driver circuits in response to the spark plug test signal and the surrogate signal;
operating the one of the driver circuits and an associated one of the plurality of switches to fire an associated one of the plurality of spark plugs in response to the firing signal; and
evaluating presence or absence of a spark of the spark plug in response to the operation of the driver circuit.

2. The process of claim 1, comprising receiving with a human machine interface an operator selection to test a spark plug, wherein the act of providing the spark plug test signal to the controller occurs in response to the operator selection.

3. The process of claim 2, wherein the human machine interface is implemented in a diagnostic tool external to an electronic control unit (ECU) in which the controller is implemented.

4. The process of claim 1, comprising:
providing a second surrogate signal to the controller, the second surrogate signal being a surrogate for the engine angle signal provided to the controller of the engine;
providing a second spark plug test signal to the controller, the second spark plug test signal corresponding to a different one of a plurality of spark plugs than the spark plug test signal;
operating the controller to output a second firing signal to a driver circuit in response to the second spark plug test signal and the second surrogate signal;
operating the driver circuit to fire a second spark plug in response to the second firing signal; and
evaluating presence or absence of a second spark of the second spark plug in response to the operation of the driver circuit.

5. The process of claim 1, wherein the act of providing the surrogate signal to the controller comprises:
generating a synthetic engine angle signal with testing hardware operatively coupled with an electronic control unit (ECU) in which the controller is implemented,
providing the synthetic engine angle signal to the controller, and
operating the controller to output the firing signal to a driver circuit in response to the synthetic engine angle signal.

6. The process of claim 5, wherein the testing hardware comprises a diagnostic tool external to the ECU.

7. The process of claim 1, wherein the act of providing the surrogate signal to the controller comprises:
generating a synthetic engine angle signal with test instructions executed by an electronic control unit (ECU) in which the controller is implemented,
providing the synthetic engine angle signal to the controller, and
operating the controller to output the firing signal to a driver circuit in response to the synthetic engine angle signal.

8. The process of claim 7, wherein the test instructions are stored in testing hardware external the ECU.

9. The process of claim 1, wherein the act of providing the surrogate signal to the controller comprises:
operating a timer to trigger a time-based spark driver command,
providing the time-based spark driver command to the controller, and
operating the controller to output the firing signal to a driver circuit in response to the time-based spark driver command.

10. The process of claim 9, wherein the timer is implemented in testing hardware external an electronic control unit (ECU) in which the controller is implemented.

11. The process of claim 1, wherein the process is performed while a hybrid vehicle system including the engine is in motion with the engine turned off.

12. A system for testing one or more spark plugs of an engine, the system comprising:
an electronic test system including one or more processors and one or more non-transitory processor-readable media configured to operate while the engine is stopped to:
provide a spark plug test signal to a controller, the controller being operatively coupled with an ignition system including a plurality of spark plugs, a plurality of switches operatively coupled with the plurality of spark plugs, and a plurality of driver circuits operatively coupled with the plurality of switches;
provide a surrogate signal to the controller, the surrogate signal being a surrogate for an engine angle signal provided to the controller during operation of the engine;
operate the controller to output a firing signal to one of the driver circuits in response to the spark plug test signal and the surrogate signal;
operate the one of the driver circuits and an associated one of the plurality of switches to fire an associated one of the plurality of spark plugs in response to the firing signal; and
evaluate presence or absence of a spark of the spark plug in response to the operation of the driver circuit.

13. The system of claim 12, comprising a human machine interface configured to receive an operator selection to test a spark plug, wherein the electronic test system is configured to provide the spark plug test signal to the controller in response to the operator selection.

14. The system of claim 13, wherein the human machine interface is implemented in a diagnostic tool external to an electronic control unit (ECU) in which the controller is implemented.

15. The system of claim 12, wherein the electronic test system is configured to:
provide a second surrogate signal to the controller, the second surrogate signal being a surrogate for the engine angle signal provided to the controller of the engine;
provide a second spark plug test signal to the controller, the second spark plug test signal corresponding to a different one of a plurality of spark plugs than the spark plug test signal;
operate the controller to output a second firing signal to a driver circuit in response to the second spark plug test signal and the second surrogate signal;
operate the driver circuit to fire a second spark plug in response to the second firing signal; and
evaluate presence or absence of a second spark of the second spark plug in response to the operation of the driver circuit.

16. The system of claim 12, wherein the electronic test system being configured to provide the surrogate signal to the controller comprises the electronic test system being configured to:
generate a synthetic engine angle signal with testing hardware operatively coupled with an electronic control unit (ECU) in which the controller is implemented,
provide the synthetic engine angle signal to the controller, and
operate the controller to output the firing signal to a driver circuit in response to the synthetic engine angle signal.

17. The system of claim 16, wherein the testing hardware comprises a diagnostic tool external to the ECU.

18. The system of claim 12, wherein the electronic test system being configured to provide the surrogate signal to the controller comprises the electronic test system being configured to:
generate a synthetic engine angle signal with test instructions executed by an electronic control unit (ECU) in which the controller is implemented,
provide the synthetic engine angle signal to the controller, and
operate the controller to output the firing signal to a driver circuit in response to the synthetic engine angle signal.

19. The system of claim 18, wherein the test instructions are stored in testing hardware external the ECU.

20. The system of claim 12, wherein the electronic test system being configured to provide the surrogate signal to the controller comprises the electronic test system being configured to:
operate a timer to trigger a time-based spark driver command,
provide the time-based spark driver command to the controller, and
operate the controller to output the firing signal to a driver circuit in response to the time-based spark driver command.

21. The system of claim 20, wherein the timer is implemented in testing hardware external an electronic control unit (ECU) in which the controller is implemented.

22. The system of claim 12, wherein the electronic test system is configured to operate while a hybrid vehicle system including the engine is in motion with the engine turned off.
